(19) United States
(12) Patent Application Publication
(10) Pub. No.: US 2015/0114397 A1
(43) Pub. Date: Apr. 30, 2015

(54) CHEMICAL AND BIOLOGICAL PROTECTION MASK

(71) Applicant: Jeffery C. Litz, Glen Burnie, MD (US)

(72) Inventor: Jeffery C. Litz, Glen Burnie, MD (US)

(21) Appl. No.: 13/784,062

(22) Filed: Mar. 4, 2013

Related U.S. Application Data
(60) Provisional application No. 61/605,824, filed on Mar. 2, 2012.

(51) Int. Cl. A62B 23/02; A62B 18/10; A62B 18/08; A62B 18/02

(52) U.S. Cl. CPC A62B 23/025; A62B 18/02; A62B 18/10; A62B 18/082
USPC 128/206.15

(57) ABSTRACT

A chemical and biological protection mask with dual-external-filter cartridges each having a photo catalytic Titanium Dioxide (TiO2) filter element, alone or in combination with activated carbon filter, combination hydrophobic-hydrophilic filter, and/or other elements, and a miniaturized high-intensity shortwave UV illumination tube internal to the mask itself illuminating both TiO2 filter elements with UVA energy, thereby generating hydroxyl radicals (OH—) which destroy microbes in the air.

### CROSS-REFERENCE TO RELATED APPLICATION(S)

The present application derives priority from U.S. Provisional Patent Application 61/605,824 filed 2 Mar. 2012, and is a continuation-in-part of U.S. application Ser. No. 12/456,431 filed Jun. 16, 2009, which was a continuation-in-part of U.S. application Ser. No. 12/385,482 filed 9 Apr. 2009, deriving priority from U.S. provisional application Ser. No. 61/193432 filed Nov. 28, 2008.

### BACKGROUND OF THE INVENTION

1. Field of the Invention

The present invention relates to protective breathing devices, and, more particularly, to a chemical and biological protection mask that combines dual-external-filter cartridges each having a photo catalytic Titanium Dioxide (TiO2) filter element, alone or in combination with an activated carbon filter, combination hydrophobic/hydrophilic membrane filters, and/or other elements, and a miniaturized high-intensity shortwave UV illumination tube internal to the mask itself illuminating both TiO2 filter elements with UVA energy, thereby generating hydroxyl radicals (OH—) which destroy microbes in the air.

2. Description of the Background

There is a wide variety of prior art with regard to gas masks and breathing gas respirators. Most conventional gas mask/respirators utilize a half-mask or full face mask that covers the nose and mouth and in the latter case the entire upper face.

Gas masks as described above use a mask portion made of impermeable material, resistant to chemical agents and a harness which allows the mask to be put on the user's head so as to provide a tight seal between the edges of the mask portion and the user's face. Once the mask is put on, the user can inhale air from the outside through an external filter canister attached to the mask portion by a threaded or twist-lock fitting. A filtering cartridge is inserted onto the fitting to decontaminate the air being inhaled. The air subsequently exhaled by the user is expelled from the mask through an outflow opening through the facepiece and provided with a one-way valve.

Conventional gas mask/respirators invariably utilize a cartridge containing various filter media. In their simplest form, the cartridges incorporate a filter cloth, charcoal, or polymeric material that merely filters out particulate materials including sprays and colloidal suspensions. Those that rely on activated charcoal filter eliminate particulate material and also adsorb vapor and gas contaminants as they come in contact with the charcoal. A more effective filtration media is a hepa-type of filter formed of pleated filter paper with minute interstices for allowing the passage of air there through.

Nano Mask, Inc. is an air filtration products manufacturer who's patented 2H Technology™ filter system has produced filtration efficiencies of greater than 99.99% at a particulate size of 0.027 microns. As described in U.S. Pat. No. 6,689,278 to Beplate issued Feb. 10, 2004, the 2H Technology™ is a combined hydrophobic-hydrophilic in which a hydrophilic filter and a hydrophobic filter are arranged serially along the flow path with a spacer there between.

Despite their effectiveness against particulate materials and suspensions, the foregoing and other known filter-type gas masks are not sufficiently effective in filtering biological organisms such as viruses and germs. With the increased threat of biological warfare, there is currently a significant need for a gas mask/respirator capable of killing germs as well as filtering toxins.

In other applications chemical agents are often used to destroy or kill germs and bacteria. However, it particularly difficult to incorporate chemical mechanisms into a gas mask.

UV radiation is another known germicidal. Germicidal ultraviolet (UVC) light kills cells by damaging their DNA. Ultraviolet photons harm the DNA molecules of living organisms and the distorted DNA molecules do not function properly, cannot replicate, and eventually the cells will die. High-intensity shortwave ultraviolet light is commonly used for disinfecting smooth surfaces such as dental tools, and ultraviolet light fixtures are often present in labs. Unfortunately, existing UV-light sources for biocidal applications are typically fluorescent UV light bulbs. These are large and for stable operation require the presence of a ballast and AC power source. The size requirements of these components is unsuitable for portable use in any gas mask, and so high-intensity shortwave ultraviolet disinfectant systems are not known in this context.

In the present inventor's co-pending U.S. application Ser. No. 12/456,431 he discloses the use of a UV-illumination tube inside the external filter canister or coupling thereto, which acts directly on the air inhaled through the filter media to destroy microbes before ingress to the mask portion. It would be more advantageous to incorporate the UV-illumination tube inside (behind) the mask portion to protect it, and to engineer it to irradiate catalytic Titanium Dioxide (TiO2) filter elements inside the externally-mounted filter canister(s) to irradiate said elements with UVA energy, thereby generating hydroxyl radicals (OH—) further increasing the biocidal effectiveness of the mask.

### SUMMARY OF THE INVENTION

It is, therefore, an object of the present invention to provide a combination chemical and biological protection mask.

It is another object to provide a combination chemical and biological protection mask in a compact portable self-contained form factor.

It is another object to provide a combination chemical and biological protection mask incorporating a catalytic Titanium Dioxide (TiO2) filter element in one or dual external cartridges with a UV illumination module internal to the mask portion for illuminating one or both TiO2 filter elements with UVA energy, thereby generating hydroxyl radicals (OH—).

It is another object of the present invention to provide a combination chemical and biological protection mask as described above with an anti-biotic nano-silver filter element also in one or dual external cartridges to enhance the effectiveness of the mask.

It is another object of the present invention to provide a combination chemical and biological protection mask as described above with a combination hydrophobic-hydrophilic filter.

These and other objects are achieved herein by a gas mask or respirator that combines one or dual external filter cartridges attachable to a mask portion, the external filter cartridges each having one or more filter elements including a photo catalytic Titanium Dioxide (TiO2) filter element (alone or in combination with an anti-biotic nano-silver filter element, activated carbon filter element, or other elements as desired), and a miniaturized high-intensity shortwave UV illumination module internal to the mask portion and oriented to illuminate both TiO2 filter elements in the external filter cartridges with UVA energy, thereby generating hydroxyl radicals (OH—) which destroy microbes in the air. The mask portion covers at least the nose and mouth of a user, and a one way exhalation valve is mounted on the mask portion. The mask portion has one or dual inhalation couplings to which the external filter canister(s) can be coupled. A novel UV-illumination module resides inside the mask portion between the inhalation valve coupling and filter canister. In a preferred embodiment the UV illumination tube further comprises an aluminum tube in communication with the inhalation coupling(s), and a UV illumination module within the tube having a plurality of UV LED lights axially mounted therein and oriented to direct UV light outward onto the TiO2 filter elements resident within the filter cannisters. The UV LED lights preferably emit light within a range of from 240 nm˜280 nm wavelength, and are powered by a battery connected to a voltage regulator, and a current chopping circuit connected between said voltage regulator and said UV LED lights for providing pulsed current thereto. An optional solar cell is disclosed for powering the UV LED lights directly or by recharging the battery, and the solar cell may be mounted atop a visor attached to said mask.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front perspective view of the gas mask 2 with two external filter canisters 40 according to a dual-filter embodiment of the present invention.

FIG. 2 is an exploded diagram of the gas mask 2 of FIG. 1 with inset cross section showing external filter canister 40 details.

FIG. 3 is an exploded diagram of the UV illumination tube 50 as in FIG. 1.

FIG. 4 is a schematic diagram of an exemplary circuit arrangement.

FIG. 5 is a perspective view of an accessory visor 90 for conveniently mounting the solar cell 80 for optimal sun exposure.

### DETAILED DESCRIPTION OF THE PREFERRED EMBODIMENT

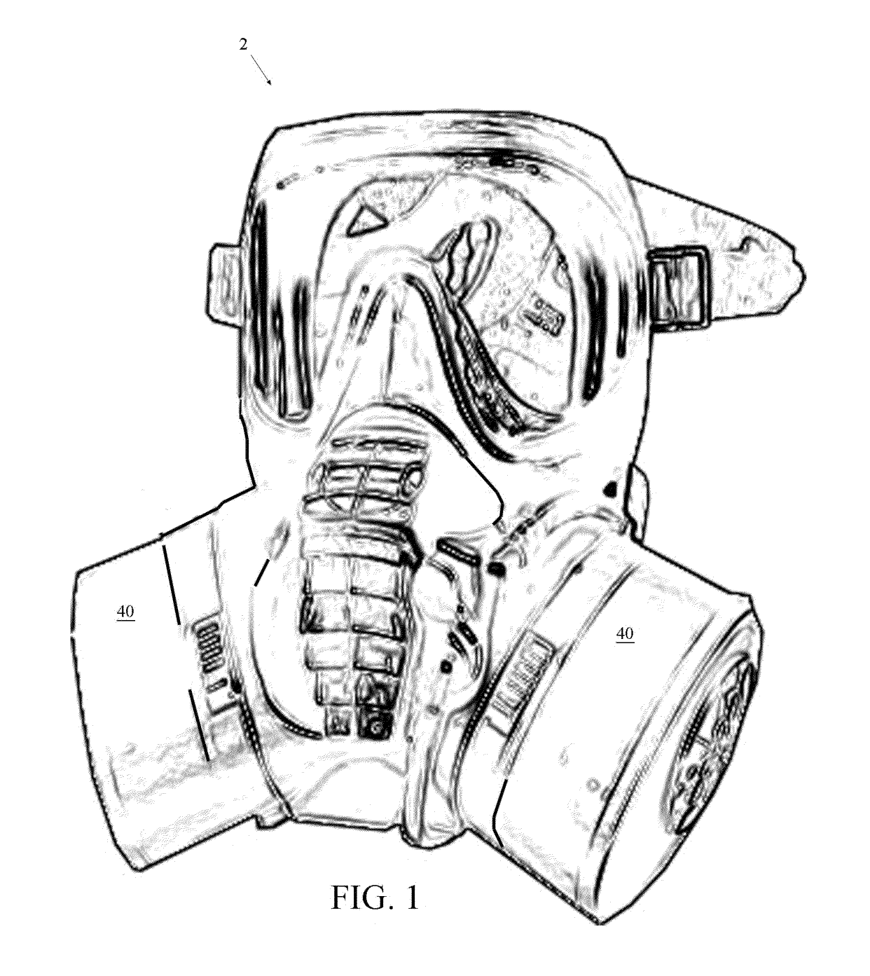

FIG. 1 is a front perspective view of the gas mask assembly 2 according to a dual-filter-canister embodiment of the present invention. One skilled in the art should understand that a single-filter variant is possible with only minor modification and is considered within the scope and spirit of the invention.

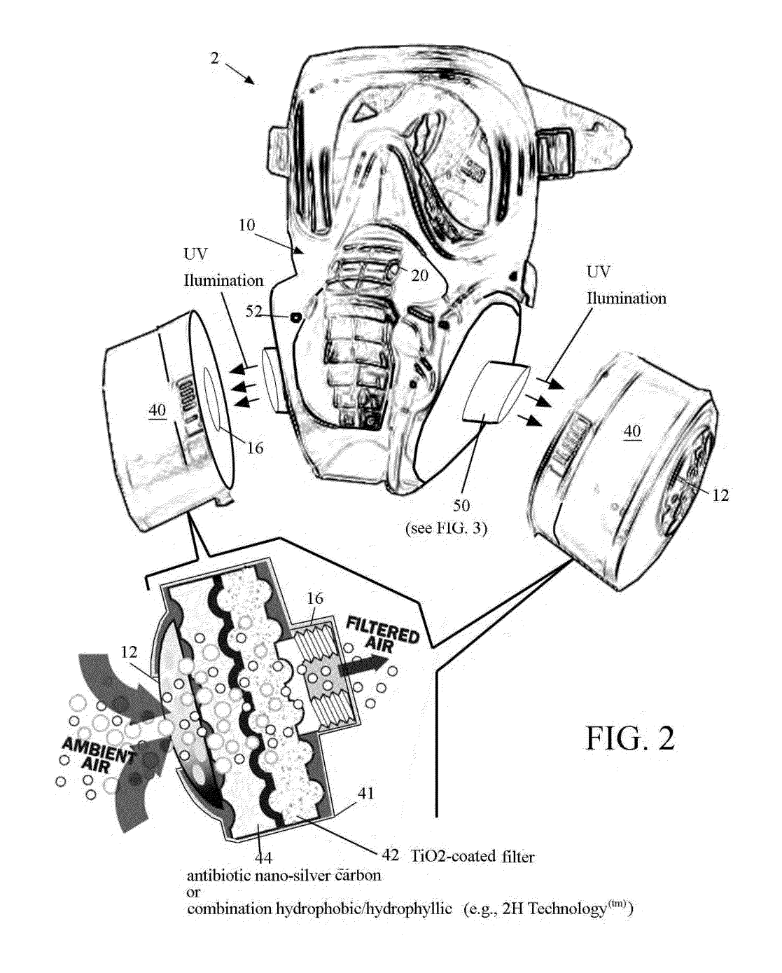

The gas mask assembly 2 generally comprises a molded mask portion 10 containing a frontal one-way exhalation valve 20, and dual filter canisters 40 each providing one or more adjacent inhalation apertures 12. In the illustrated embodiment both dual filter canisters 40 are equipped with a push-and-twist receptacle 16 (obscured, see FIG. 2) by which they can be coupled to the mask portion 10. The molded mask portion 10 with frontal one-way exhalation valve 20 is known in the art and readily available. As an example, AVON™ Rubber's Protection Division produces a variety of suitable full and half-masks for purchase by law enforcement, first-responder, counter-terrorist and military teams, as well as a variety of canister filtration units.

Referring now to FIG. 2, the lower inset illustrates a cross-section of an exemplary filter canister 40. Each filter canister 40 generally comprises a molded annular housing 41 with an inlet grate serving as inhalation aperture 12, aperture 12 leading into the enclosed filter element housing 41. Preferably at least two separate disc-like filter elements 42, 44 are sandwiched inside the housing 41 of canister 40. It is essential that the innermost filter element 42 proximate the mask portion 10 be a TiO2 filter element. Preferably, innermost filter element 42 comprises a TiO2-coated filter mesh substrate. For example, innermost filter element 42 may be a honeycomb-shaped aluminum grid or pad with lattice/mesh openings ranging from 10 to 180 μm to serve as a carrier, and coated with TiO2 as a photocatalyst. The innermost filter element 42 must remain in direct visual exposure through push-and-twist receptacle 16 when coupled to the mask portion 10. The outer filter element 44 proximate the inhalation aperture 12 is preferably a nano-silver activated carbon filter element or, alternatively, a combination hydrophobic-hydrophilic filter such as described in U.S. Pat. No. 6,689,278 to Beplate issued Feb. 10, 2004 and sold under the Nano Mask, Inc. 2H Technology™ brand.

If the outer filter element 44 comprises a nano-silver activated carbon filter element, it comprises an annular polypropylene pillow filled with a layer of activated charcoal. The poly walls of outer filter element 44 are coated with a 45.0 nm layer of nano silver particles. This nano-coating technology has a known anti-bacterial function since silver is a natural anti-bacterial and antifungal agent.

If the outer filter element 44 comprises a combination hydrophobic-hydrophilic filter such as described in the '278 patent to Beplate, it generally includes one or more hydrophilic filters, one or more hydrophobic filters, and a spacer located between them.

When the outer filter element 44 is used in combination with the TiO2 photocatalyst filter element 42 the combination yields 99.9% biocidal efficiency. One skilled in the art should understand that additional filter elements may be added without departing from the scope or spirit of the invention.

In accordance with the present invention, a UV-illumination tube 50 straddles the mask portion 10 and couples the dual filter assemblies 40 together. The UV illumination tube 50 is a short 2-5″ multi-part cylinder with mating push-and-twist receptacle/seats at each end for seating the opposing filter assemblies 40 and inserted through mask 10. The UV illumination tube 50 further comprises a cylindrical aluminum outer shell, and a cylindrical plastic insert (described below) that seats a plurality of elongate axially-aligned circuit boards each carrying a plurality of surface-mount LED UV lights disposed angularly outward from the ends of tube 50. The UV illumination tube 50 is centrally unobscured and incoming air from filter assemblies 40 remains free to pass through into the mask 10. The surface-mount LED UV lights shine outward from the ends of tube 50 onto the TiO2 filter element(s) for activation of the photocatalyst. Photocatalytic oxidation (PCO) is achieved by combining UV light rays with the TiO2 coated filter element 42. This process creates hydroxyl radicals and super-oxide ions, which are highly reactive electrons. These highly reactive electrons aggressively combine with other elements in the air, such as bacteria and VOCs. (formaldehyde, ammonia and many other common contaminates). Once bound together, the chemical reaction takes place between the super-charged ion and the pollutant, effectively “oxidizing” (or burning) the pollutant. This breaks the pollutant down into harmless carbon dioxide and water molecules, making the air more purified. In addition, air from the filter cannisters 40 passes along the length of tube 50 and is directly UV-illuminated with high-intensity shortwave ultraviolet light from the LEDs, providing enhanced chemical and biological protection. Power for the LEDs is derived from an on-board battery which may be built into the UV illumination tube 50 or the mask 10 (requiring slide-connectors along the lip of the tube 50), and/or from a solar cell (to be described) likewise mounted on the UV illumination tube 50 or the mask 10. Preferably, an on/off detent switch 52 is provided on the mask portion 10 as well for illuminating tube 40.

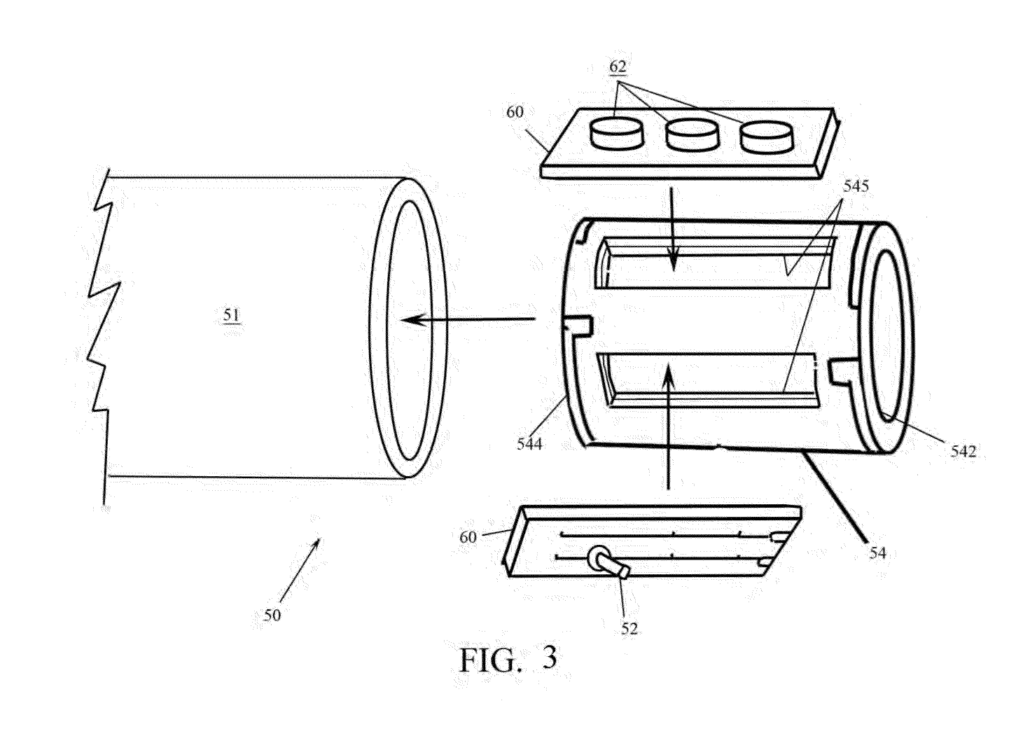

FIG. 3 is an exploded diagram of the UV illumination tube 50 as in FIG. 2. The UV illumination tube 50 further comprises a cylindrical aluminum outer shell 51, and a substantially cylindrical plastic insert 54 that fits conformingly within the outer shell 51. For manufacturing convenience, the plastic insert 54 is slightly longer than the aluminum outer shell 51 and protrudes at both ends, and this way mating push-and-twist receptacle 544 and push-and-twist seat 542 may be integrally molded at the opposing ends of the insert 54. One skilled in the art should understand that push-and-twist receptacle 544 and seat 542 may be replaced by screw threads, bayonet-type or any other anchoring fixtures as a matter of design choice.

The plastic insert 54 is further formed with a plurality (here four) pass-through windows 545, though one or more may suffice. The pass-through windows 545 are elongate rectangular apertures equally-spaced and axially-aligned about the center axis of the insert 54, and opening centrally into the hollow of the insert 54. Each pass-through windows 545 is formed with a peripheral lip to seat a corresponding circuit board 60.

The circuit board(s) 60 are likewise elongate rectangular printed circuit boards each carrying a plurality of solder-mount UV-emitting LEDs 62 protruding from one side. The UV LEDS 62 are generally low-power LEDs that shine with deep UV light for fluorescence sterilization. It has been found that the strongest disinfection occurs over the wavelengths of 240 nm˜280 nm, and so a sealed 500 uW UV LED emitting within that range is suitable. For example, Sensor Electronic Technology, Inc. supplies a line of suitable UVTOP® Deep ultraviolet Light Emitting Diodes containing an AlGaN/GaN LED chip in a sealed TO39 double-lead package. Optical power out is ˜500 uW. Forward current is 30 mA, pulsed current to 200 mA at 1% duty cycle, forward voltage 5.5V, reverse voltage 6 V. Peak wavelength is 250 nm, peak width is 12 nm (full width half max). The UV LEDs 62 are equally-spaced along the circuit board(s) 60 with windows directed inward and outward toward the distal ends of the insert 54. The UV LEDs 62 may be seated on the circuit board(s) 60 at an angle so that their primary illumination window is directed toward the TiO2 filter 42, thereby ensuring that the LED light shines directly onto the TiO2 filter media. The backside of the circuit board(s) 60 contain serial printed circuit connections to the LED leads. One circuit board 60 contains a voltage regulator connected to a current chopper circuit for outputting pulsed current of 200 mA at 1% duty cycle at a forward voltage of 5.5V to the series-connected LEDs. A variety or power supply options are possible, including minimally a lithium ion battery mounted on one of the circuit boards 60 proximate the voltage regulator. One skilled in the art should understand that the battery may be mounted elsewhere, including in the mask 10 itself, in which case appropriate wiring and connection terminals are provided to the circuit board 60.

In the preferred embodiment, to prevent frequent battery replacement, a solar recharging cell is provided. This can be mounted anywhere on the surface of the tube 50 or mask 10, and as described below is preferably mounted on an accessory visor attached to the mask for optimal sunlight exposure.

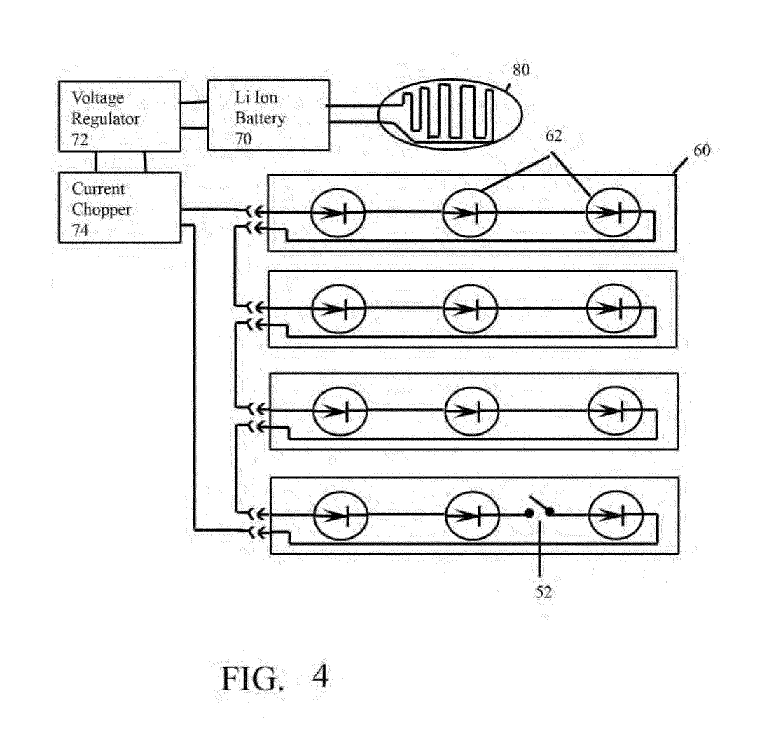

FIG. 4 is a schematic diagram of an exemplary circuit arrangement. Here twelve UV LEDs 62 are evenly divided among four circuit boards 60 and are connected in series by printed circuit connections. One circuit board 60 contains the mounted detent switch 52 for selectively breaking the LED circuit. The series-connected LEDs are connected to a current chopper circuit 74 that outputs pulsed current of 200 mA at 1% duty cycle at a forward voltage of 5.5V to the series-connected LEDs. The current chopper circuit 74 is connected to a voltage regulator 72 for regulating the 5.5V input power, and voltage regulator is connected to a lithium ion (or other suitable) battery 70. The battery 70 is in turn optionally connected to a solar recharging circuit 80 mounted in an exposed position on the aluminum tube 51 or elsewhere on the mask 10.

A variety or power supply options are possible, including minimally a lithium ion battery mounted on one of the circuit boards 60 proximate the voltage regulator.

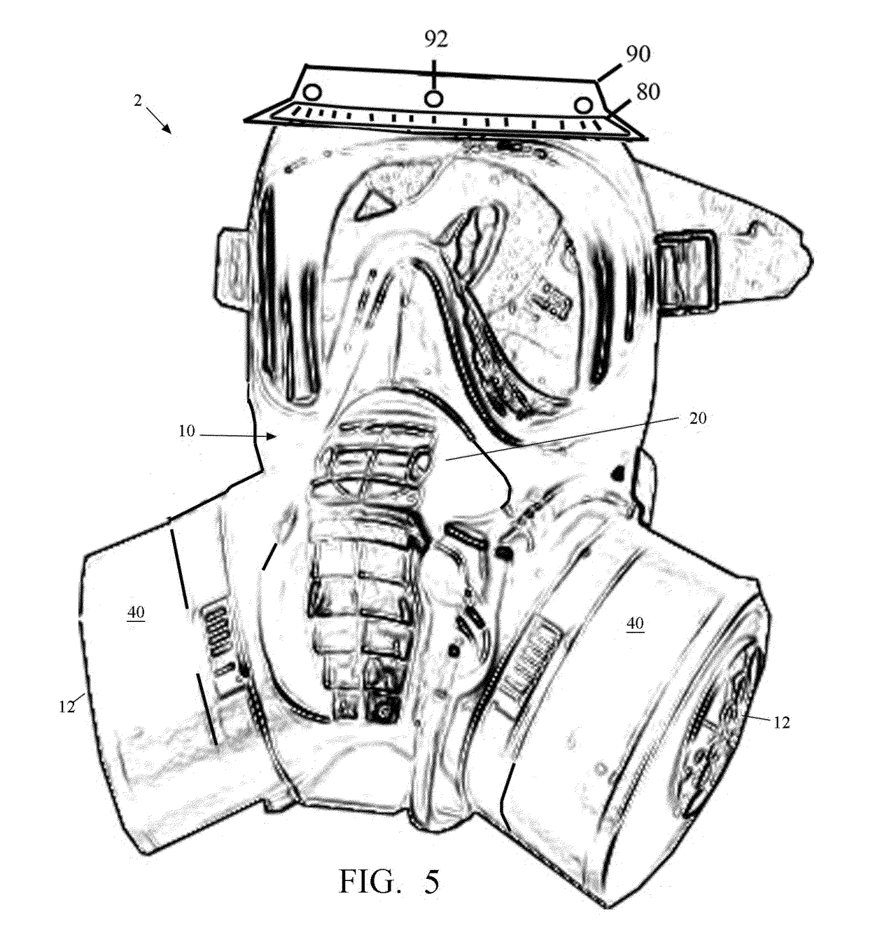

FIG. 5 is a perspective view of an accessory visor 90 for conveniently mounting the solar cell 80 for optimal sun exposure. Visor 90 is attached by snaps 92 or other fasteners above the brow of the mask 10 to serve as a sun shield. The visor 90 includes a brim upon which the solar cell 80 may be adhered lengthwise for optimal exposure to the sun, and optimal recharging capability. The wiring to the solar cell 80 may be conveniently run down through the peripheral rubber flanges of the mask 10 to the UV illumination tube 50 where they remain hidden. One skilled in the art will readily understand that the solar cell 80 may be relied upon to fully power the LEDs 62, in which case the battery 70 can be eliminated, though primary or at least backup battery power is preferred. It should now be apparent that the above-described invention provides a novel combination chemical and biological protection mask in a compact portable self-contained form factor to which conventional gas mask users are well-accustomed, and the a miniaturized low-power UV LED-light array incorporated therein adds a completely new level of biological protection to the capabilities of an otherwise conventional filter mask.

Indeed, it should be understood that various changes may be made in the form, details, arrangement and proportions of the parts. Such changes do not depart from the scope of the invention which comprises the matter shown and described herein and set forth in the appended claims.

I claim:

1. A gas mask for operation in contaminated areas, comprising:
a mask portion for covering at least the nose and mouth of a user;
a one way exhalation valve mounted on said mask portion;
a UV-illumination tube in said mask portion, said UV illumination tube further comprising a central air passage and a plurality of UV lights arranged about said central air passage;
at least one filter assembly mounted external to said mask portion and in fluid communication with said UV illumination tube, said at least one filter assembly comprising a filter housing and a photocatalytic TiO2 coated filter element contained inside said filter housing.

2. The gas mask according to claim 1, wherein said at least one filter assembly further comprises a silver nano-coated filter element contained inside said filter housing.

3. The gas mask according to claim 1, wherein said at least one filter assembly further comprises a combination hydrophobic-hydrophilic filter.

4. The gas mask according to claim 1, wherein when said at least one filter assembly mounted external to said mask portion is exposed to said plurality of UV lights when said filter assembly is mounted external to said mask portion.

5. The gas mask according to claim 1, wherein said at least one filter assembly further comprises a combination hydrophobic-hydrophilic filter.

6. The gas mask according to claim 1, wherein said at least one filter assembly further comprises a plurality of filter elements each having a different filter media, said photocatalytic TiO2 coated filter element being the most proximate of said plurality of filter elements to said plurality of UV lights when said filter assembly is mounted to said mask portion.

7. The gas mask according to claim 1, wherein said at least one filter assembly further comprises a silver nano-coated filter element contained inside said filter housing.

8. The gas mask according to claim 1, wherein said at least one filter assembly further comprises two separate filter assemblies attachable to opposing sides of said mask portion.

9. The gas mask according to claim 8, wherein said two separate filter assemblies both further comprise a housing, and a silver nano-coated filter element contained inside said filter housing.

10. The gas mask according to claim 9, wherein said at least one filter assembly further comprises a plurality of filter elements each having a different filter media, said photocatalytic TiO2 coated filter element being the most proximate of said plurality of filter elements to said plurality of UV lights when said filter assembly is mounted to said mask portion.

11. The gas mask according to claim 1, wherein said two separate filter assemblies both further comprise a plurality of filter elements each having a different filter media, their repective photocatalytic TiO2 coated filter elements being the most proximate of said plurality of filter elements to said plurality of UV lights when said filter assembly is mounted to said mask portion.

12. The gas mask according to claim 1, wherein said plurality of UV lights are LED UV lights.

13. The gas mask according to claim 11, wherein said plurality of UV lights are LED UV lights.

14. A gas mask for operation in contaminated areas, comprising:
a mask portion for covering at least the nose and mouth of a user;
a one way exhalation valve mounted on said mask portion;
a filtering apparatus further comprising a UV-illumination tube mounted inside said mask portion and at least one filter assembly connected in fluid communication with said UV illumination tube;
said UV illumination tube further comprising a central air passage and a plurality of UV lights arranged about said central air passage; and
said filter assembly comprising a filter housing and a photocatalytic TiO2 coated filter element contained inside said filter housing.

15. The gas mask according to claim 14, wherein said plurality of UV lights are LED UV lights.

16. A gas mask for operation in contaminated areas, comprising:
a mask portion for covering at least the nose and mouth of a user;
a one way exhalation valve mounted on said mask portion;
a filtering apparatus further comprising a UV-illumination tube mounted external to said mask portion and at least one filter assembly connected in fluid communication with said UV illumination tube;
said UV illumination tube further comprising a central air passage and a plurality of UV lights arranged about said central air passage; and
said filter assembly comprising a filter housing and a photocatalytic TiO2 coated filter element contained inside said filter housing.

17. The gas mask according to claim 16, wherein said plurality of UV lights are LED UV lights.
